(19) United States
(12) Patent Application Publication
(10) Pub. No.: US 2023/0312894 A1
(43) Pub. Date: Oct. 5, 2023

(54) BIMODAL POLYETHYLENE COPOLYMERS FOR PE-80 PIPE APPLICATIONS

(71) Applicant: Univation Technologies, LLC, Houston, TX (US)

(72) Inventors: Rujul M. Mehta, Manvel, TX (US); Timothy R. Lynn, Glen Gardner, NJ (US); Cliff R. Mure, Bound Brook, NJ (US); Chuan C. He, Houston, TX (US)

(21) Appl. No.: 18/043,787

(22) PCT Filed: Sep. 24, 2021
(86) PCT No.: PCT/US2021/051861

§ 371 Date: Mar. 2, 2023

Related U.S. Application Data
(60) Provisional application No. 63/085,396, filed on Sep. 30, 2020.

(51) Int. Cl. C08L 23/08

(52) U.S. Cl. CPC C08L 23/0815; C08L 2203/18; C08L 2205/025

(57) ABSTRACT

A bimodal poly(ethylene-co-1-hexene) copolymer composition, methods of making and using, and manufactured articles made therefrom and uses thereof.

### FIELD

Polyethylene compositions, formulations containing same, methods of making and using same, and articles containing same.

### INTRODUCTION

Patent applications and patents in the field include US 2005/0054790 A1; US 2015/0017365 A1; WO 2019/046085 A1; U.S. Pat. Nos. 7,250,473 B2; and 9,017,784 B2.

### SUMMARY

We provide a bimodal poly(ethylene-co-1-hexene) copolymer composition having an inventive combination of overall properties as described below. The bimodal poly(ethylene-co-1-hexene) copolymer composition may be formulated with one or more additives. The composition may be made by copolymerization of ethylene and 1-hexene using a bimodal catalyst system described herein. The composition and its formulation may independently be shaped or fabricated to make useful manufactured articles.

### DETAILED DESCRIPTION

We provide a bimodal poly(ethylene-co-1-hexene) copolymer composition having an inventive combination of overall properties as described below. The bimodal poly(ethylene-co-1-hexene) copolymer composition may be formulated with one or more additives. The composition may be made by copolymerization of ethylene and 1-hexene using a bimodal catalyst system described herein. The composition and its formulation may independently be shaped or fabricated to make useful manufactured articles.

The bimodal poly(ethylene-co-1-hexene) copolymer composition advantageously will meet the requirements for PE-80 pipe applications. ISO 4427 and ISO 4437 define pressure pipe categories as PE 40, PE 63, PE 80, and PE 100 categories. The bimodal poly(ethylene-co-1-hexene) copolymer composition will meet requirements for PE-80 pipe, which requirements include: a compound density≥930 kilogram per cubic meter (kg/m³) measured on a formulation consisting of the bimodal poly(ethylene-co-1-hexene) copolymer composition and additives according to ASTM D792-13 Method B, a melt index I₅ 0.2 to 1.4 g/10 min. (190° C., 5.00 kg); a Minimum Required Strength (MRS) per ISO 9080 of at least 8.0 MPa, and a slow crack growth resistance per ISO 13479 of at least 500 hours at 8.0 MPa (8.0 bar).

Certain inventive embodiments are described below as numbered aspects for easy cross-referencing. Additional embodiments are described elsewhere herein.

Aspect 1. A bimodal poly(ethylene-co-1-hexene) copolymer composition comprising a lower molecular weight poly(ethylene-co-1-hexene) copolymer constituent (LMW Copolymer) and a higher molecular weight poly(ethylene-co-1-hexene) copolymer constituent (HMW Copolymer), wherein each of the LMW Copolymer and HMW Copolymer independently consists essentially of ethylene-derived monomeric units and 1-hexene-derived comonomeric units; and wherein the bimodal poly(ethylene-co-1-hexene) copolymer composition is characterized by each of limitations (a) to (h): (a) a resolved bimodality (resolved molecular weight distribution) showing in a chromatogram of gel permeation chromatography (GPC) of the bimodal low density polyethylene composition, wherein the chromatogram shows a peak representing the HMW Copolymer, a peak representing the LMW Copolymer, and a local minimum therebetween in a range of Log(molecular weight) (“Log(MW)”) 5.0 to 7.0, measured according to the Bimodality Test Method; (b) a density from 0.935 to 0.941 gram per cubic centimeter (g/cm³) measured according to ASTM D792-13 Method B; (c) a melt index measured according to ASTM D1238-13 at 190 degrees C. (° C.) under a load of 2.16 kilograms (kg) (“I₂”) from 0.05 to 0.14 gram per 10 minutes (g/10 min.); (d) a flow index measured according to ASTM D1238-13 at 190° C. under a load of 21.6 kg (“I₂₁”) from 9.0 to 13 g/10 min.; (e) a flow rate ratio of the melt index to the flow index (“I₂₁/I₂”) from 100.0 to 250.0; (f) from 1 to 14 weight percent (wt %) of ethylenic-containing chains having a formula molecular weight (MW) of from greater than 0 to 10,000 grams per mole (g/mol), based on total weight of ethylenic-containing constituents in the bimodal poly(ethylene-co-1-hexene) copolymer composition; (g) a molecular mass dispersity (M_{W}/Mₙ), D_{M}, from 7 to 25 measured according to the Gel Permeation Chromatography (GPC) Test Method; and (h) a melt index measured according to ASTM D1238-13 at 190 degrees C. (° C.) under a load of 5.00 kilograms (kg) (“I₅” or “MI5”) from 0.25 to 0.50 gram per 10 minutes (g/10 min.).

Aspect 2. The bimodal poly(ethylene-co-1-hexene) copolymer composition of aspect 1 characterized by at least one of limitations (a) to (h): (a) the local minimum in the GPC chromatogram is from 5.0 to 6.0 Log(MW), measured according to the Bimodality Test Method; (b) density from 0.935 to 0.937 g/cm³, measured according to ASTM D792-13 Method B; (c) melt index (I₂) of 0.08 to 0.10 g/10 min. (e.g., 0.09±0.005 g/10 min.) measured according to ASTM D1238-13 (190° C., 2.16 kg); (d) flow index (I₂₁) of 11 to 13 g/10 min.; (e) a flow rate ratio (I₂₁/I₂) from 115 to 150; and (f) from 7.0 to less than 12.0 wt % of ethylenic-containing chains having MW of from greater than 0 to 10,000 g/mol, based on total weight of the ethylenic-containing constituents in the bimodal poly(ethylene-co-1-hexene) copolymer composition; (g) molecular mass dispersity (M_{w}/Mₙ), D_{M}, from 15 to 20 measured according to the Gel Permeation Chromatography (GPC) Test Method; and (h) a melt index measured according to ASTM D1238-13 at 190 degrees C. (° C.) under a load of 5.00 kilograms (kg) (“I₅” or “MI5”) from 0.40 to 0.50 g/10 min. (e.g., 0.45±0.01 g/10 min.). In some embodiments the I₂ may be 0.09±0.005 g/10 min., the I₂₁ may be 12±0.5 g/10 min., the I₂₁/I₂ may be 133±5, and the I₅ may be 0.45±0.01 g/10 min.

Aspect 3. The bimodal poly(ethylene-co-1-hexene) copolymer composition of aspect 1 characterized by at least one of limitations (a) to (h): (a) the local minimum in the GPC chromatogram is from 5.0 to 6.0 Log(MW), measured according to the Bimodality Test Method; (b) density from 0.939 to 0.941 g/cm³, measured according to ASTM D792-13 Method B; (c) melt index (I₂) of from 0.07 to 0.09 g/10 min. (e.g., 0.08±0.005 g/10 min.) measured according to ASTM D1238-13 (190° C., 2.16 kg); (d) flow index (I₂₁) of 9.0 to 11 g/10 min.; (e) a flow rate ratio (I₂₁/I₂) from 115 to 150; and (f) from 7.0 to less than 12.0 wt % of ethylenic-containing chains having MW of from greater than 0 to 10,000 g/mol, based on total weight of the ethylenic-containing constituents in the bimodal poly(ethylene-co-1-hexene) copolymer composition; and (g) molecular mass dispersity (M_{w}/Mₙ), D_{M}, from 15 to 20 measured according to the Gel Permeation Chromatography (GPC) Test Method; and (h) a melt index measured according to ASTM D1238-13 at 190 degrees C. (° C.) under a load of 5.00 kilograms (kg) (“I₅” or “MI5”) from 0.25 to 0.35 g/10 min. (e.g., 0.30±0.01 g/10 min.). In some embodiments the I₂ may be 0.08±0.005 g/10 min., the I₂₁ may be 10±0.5 g/10 min., the I₂₁/I₂ may be 125±5, and the I₅ may be 0.30±0.01 g/10 min.

Aspect 4. The bimodal poly(ethylene-co-1-hexene) copolymer composition of any one of aspects 1 to 3 further characterized by any one of limitations (i) to (k): (i) a minimum required strength (MRS) of at least 8.0 MPa, determined in accordance with ISO 9080:2003 from long-term pressure testing conducted according to ISO 12162:2009; (j) a resistance to slow crack growth of at least 500 hours, measured at 0.8 megapascal (MPa; 8.0 bar) pressure according to ISO 13479:2009; (k) a resistance to slow crack growth of from 500 to 9,990 hours, measured at 80° C. and 2.4 megapascals (MPa) pressure according to a Pennsylvania Notch Test (“PENT”) according to ASTM F1473-18. In some embodiments the bimodal poly(ethylene-co-1-hexene) copolymer composition is characterized by a combination of any one of limitations (l) to (o):; (l) both limitations (i) and (j); (m) both limitations (i) and (k); (n) both limitations (j) and (k); and (o) each of limitations (i) to (k).

Aspect 5. A method of making the bimodal poly(ethylene-co-1-hexene) copolymer composition of any one of aspects 1 to 4, the method comprising contacting ethylene (monomer) and 1-hexene (comonomer) with a mixture of a bimodal catalyst system and a trim solution in the presence of molecular hydrogen gas (H₂) and an induced condensing agent (ICA) in one polymerization reactor under copolymerizing conditions, thereby making the bimodal poly(ethylene-co-1-hexene) copolymer composition; wherein prior to being mixed together the trim solution consists essentially of a (tetramethylcyclopentadienyl)(n-propylcyclopentadienyl)zirconium dimethyl complex and an inert liquid solvent (e.g., mineral oil) and the bimodal catalyst system consists essentially of an activator species, a non-metallocene ligand-Group 4 metal complex, and a metallocene ligand-Group 4 metal complex, a solid support, and, optionally, a mineral oil; and wherein the copolymerizing conditions comprise a reaction temperature from 94° to 96° C.; a molar ratio of the molecular hydrogen gas to the ethylene (H₂/C₂ molar ratio) from 0.0011 to 0.0013; and a molar ratio of the 1-hexene comonomer (C₆) to the ethylene (C₆/C₂ molar ratio) from 0.005 to 0.015, alternatively from 0.008 to 0.015, alternatively from 0.01 to 0.015. The H₂ may be present in the reactor at a concentration measured by gas chromatography (GC).

Aspect 6. The method of aspect 5 wherein the non-metallocene ligand-Group 4 metal complex consists essentially of bis(2-pentamethylphenylamido)ethyl)amine zirconium dibenzyl complex and the metallocene ligand-Group 4 metal complex consists essentially of (tetramethylcyclopentadienyl)(n-propylcyclopentadienyl)zirconium dimethyl complex in a molar ratio thereof from 1.0:1.0 to 5.0:1.0; and wherein the activator species is a methylaluminoxane species; and wherein the solid support is a hydrophobic fumed silica, and wherein the bimodal catalyst system is made by spray-drying a mixture of the non-metallocene ligand-Group 4 metal complex, the metallocene ligand-Group 4 metal complex, and the activator species onto the solid support.

Aspect 7. A polyethylene formulation comprising the bimodal poly(ethylene-co-1-hexene) copolymer composition of any one of aspects 1 to 4 and at least one additive selected from the group consisting of one or more antioxidants, a polymer processing aid, a colorant (e.g., a carbon black), a lubricant (e.g., a mineral oil), and a metal deactivator. Embodiments of the polyethylene formulation may have a compound density greater than or equal to (≥)930 kg/m³, measured on a formulation consisting of the bimodal poly(ethylene-co-1-hexene) copolymer composition and additives according to ASTM D792-13 Method B. Such embodiments of the polyethylene formulation may be used to manufacture the PE-80 pipe described later.

Aspect 8. A manufactured article comprising a shaped form of the bimodal poly(ethylene-co-1-hexene) copolymer composition of any one of aspects 1 to 4 or a shaped form of the polyethylene formulation of aspect 7.

Aspect 9. A pipe defining an interior volumetric space through which a substance may be conveyed, wherein the pipe is composed of either the bimodal poly(ethylene-co-1-hexene) copolymer composition of any one of aspects 1 to 4 or the polyethylene formulation of aspect 7; and wherein the pipe is characterized by the limitations (i) and (j) and, optionally, limitation (k): (i) a minimum required strength (MRS) of at least 8.0 MPa, determined in accordance with ISO 9080:2003 from long-term pressure testing conducted according to ISO 12162:2009; and (j) a resistance to slow crack growth of at least 500 hours, measured at 0.8 megapascal (MPa; 8.0 bar) pressure according to ISO 13479:2009; and, optionally, (k) a resistance to slow crack growth of from 500 to 9,990 hours, measured at 80° C. and 2.4 megapascals (MPa) pressure according to a Pennsylvania Notch Test (“PENT”) according to ASTM F1473-18. The pipe may be a PE-80 compliant pipe, which means it meets or exceeds the PE-80 pipe requirements described earlier in paragraph [0005] and below in paragraph [0019].

Aspect 10. A method of conveying a substance, the method comprising moving a substance through the interior volumetric space of the pipe of aspect 9. The substance may be a fluid or a particulate solid, alternatively a fluid. The fluid may be a liquid, a vapor, or a gas; alternatively a liquid; alternatively a vapor or a gas; alternatively a vapor; alternatively a gas.

A property of the bimodal poly(ethylene-co-1-hexene) copolymer composition may be referred to herein as an “overall property”.

A property of the LMW Copolymer may be referred to as an LMW Copolymer property and a property of the HMW Copolymer may be referred to as an HMW Copolymer property.

PE-80 pipe performance-compliant embodiments of the bimodal poly(ethylene-co-1-hexene) copolymer composition will have the compound density≥930 kg/m₃, the melt index I₅ 0.2 to 1.4 g/10 min. (190° C., 5.00 kg); the Minimum Required Strength (MRS) per ISO 9080 of at least 8.0 MPa, and the slow crack growth resistance per ISO 13479 of at least 500 hours at 8.0 MPa (8.0 bar).

Each of the LMW Copolymer and HMW Copolymer independently consists essentially of ethylene-derived monomeric units and 1-hexene-derived comonomeric units. This consists essentially of means the LMW and HMW Copolymers are substantially free of, or completely free of, constitutional units that are not derived from polymerization of ethylene or 1-hexene. Substantially free of means containing from 1 to less than 5 wt %, alternatively from 1 to 3 wt %, and free of means 0.0 wt %, of constitutional units derived from a comonomer that is not ethylene or 1-hexene.

To remove all doubt, the bimodal poly(ethylene-co-1-hexene) copolymer composition may have an amount of ethylenic-containing chains having a MW of greater than 10,000 g/mol equal to 100.0 wt % minus the from 1 to 14 wt % of ethylenic-containing chains having a MW of from greater than 0 to 10,000 g/mol described in limitation (f). In the bimodal poly(ethylene-co-1-hexene) copolymer composition, the MW of the lightest mass constituent may be different from embodiment to embodiment, so expression of MW in (f) as “from greater than 0 to 10,000 grams per mole” (i.e., from >0 to 10,000 g/mol) is a clear way to encompass all such embodiments. The term “ethylenic-containing chains” means macromolecules of ethylenic-containing constituents, which in turn are oligomers and/or polymers of ethylene and, optionally, one or more comonomers (e.g., alpha-olefins). The ethylenic-containing constituents include the LMW Copolymer and HMW Copolymer of the bimodal poly(ethylene-co-1-hexene) copolymer composition.

The terms “formula molecular weight” and “MW” mean the same thing and are mass of a macromolecule calculated from its molecular formula.

The bimodal poly(ethylene-co-1-hexene) copolymer composition may contain residue or by-products formed from the bimodal catalyst system and trim solution used to make the bimodal poly(ethylene-co-1-hexene) copolymer composition. These residuals or by-products do not affect the properties of the bimodal poly(ethylene-co-1-hexene) copolymer composition.

The polyethylene formulation comprises the inventive bimodal poly(ethylene-co-1-hexene) copolymer composition and one or more additives. Examples of such additives are antioxidants, polymer processing aids (for polymer processing such as extrusion), colorants, lubricants, and metal deactivators. Additional additives that may be included in the polyethylene formulation are one or more of oxygen scavengers, chlorine scavengers, and water extraction resistance compounds.

In some aspects the bimodal poly(ethylene-co-1-hexene) copolymer composition is (i) free of titanium, (ii) free of hafnium, or (iii) free of both Ti and Hf.

10,000. A number equal to 1.0000×10⁴, alternatively 10,000.0.

Activator (for activating procatalysts to form catalysts). Also known as co-catalyst. Any metal containing compound, material or combination of compounds and/or substances, whether unsupported or supported on a support material, that can activate a procatalyst to give a catalyst and an activator species. The activating may comprise, for example, abstracting at least one leaving group (e.g., at least one X in any one of the structural formulas in FIG. 1) from a metal of a procatalyst (e.g., M in any one of the structural formulas in FIG. 1) to give the catalyst. The catalyst may be generically named by replacing the leaving group portion of the name of the procatalyst with “complex”. For example, a catalyst made by activating bis(2-pentamethylphenylamido)ethyl)amine zirconium dibenzyl may be called a “bis(2-pentamethylphenylamido)ethyl)amine zirconium complex”. A catalyst made by activating (tetramethylcyclopentadienyl)(n-propylcyclopentadienyl)zirconium dichloride or (tetramethylcyclopentadienyl)(n-propylcyclopentadienyl)zirconium dimethyl may be called a “(tetramethylcyclopentadienyl)(n-propylcyclopentadienyl)zirconium complex”. The catalyst made by activating (tetramethylcyclopentadienyl)(n-propylcyclopentadienyl)zirconium dichloride may be the same as or different than the catalyst made by activating (tetramethylcyclopentadienyl)(n-propylcyclopentadienyl)zirconium dimethyl. The metal of the activator typically is different than the metal of the procatalyst. The molar ratio of metal content of the activator to metal content of the procatalyst(s) may be from 1000:1 to 0.5:1, alternatively 300:1 to 1:1, alternatively 150:1 to 1:1. The activator may be a Lewis acid, a non-coordinating ionic activator, or an ionizing activator, or a Lewis base, an alkylaluminum, or an alkylaluminoxane. The alkylaluminum may be a trialkylaluminum, alkylaluminum halide, or alkylaluminum alkoxide (diethylaluminum ethoxide). The trialkylaluminum may be trimethylaluminum, triethylaluminum (“TEAI”), tripropylaluminum, triisobutylaluminum, and the like. The alkylaluminum halide may be diethylaluminum chloride. The alkylaluminoxane may be a methyl aluminoxane (MAO), ethyl aluminoxane, or isobutylaluminoxane. The activator may be a MAO that is a modified methylaluminoxane (MMAO). The corresponding activator species may be a derivative of the Lewis acid, non-coordinating ionic activator, ionizing activator, Lewis base, alkylaluminum, or alkylaluminoxane, respectively. The activator species may have a different structure or composition than the activator from which it is derived and may be a by-product of the activation of the procatalyst or a derivative of the byproduct. An example of the derivative of the byproduct is a methylaluminoxane species that is formed by devolatilizing during spray-drying of a bimodal catalyst system made with methylaluminoxane. The activator may be commercially available. An activator may be fed into the polymerization reactor(s) (e.g., one fluidized bed gas phase reactor) in a separate feed from that feeding the reactants used to make the bimodal catalyst system (e.g., supported bimodal catalyst system) and/or the trim solution thereinto. The activator may be fed into the polymerization reactor(s) in “wet mode” in the form of a solution thereof in an inert liquid such as mineral oil or toluene, in slurry mode as a suspension, or in dry mode as a powder.

The bimodal catalyst system may be fed into the single polymerization reactor in “dry mode” or “wet mode”, alternatively dry mode, alternatively wet mode. The dry mode is fed in the form of a dry powder or granules. The wet mode is fed in the form of a suspension of the bimodal catalyst system in an inert liquid such as mineral oil. The bimodal catalyst system is commercially available under the PRODIGY™ Bimodal Catalysts brand, e.g., BMC-200, from Univation Technologies, LLC.

Consisting essentially of, consist(s) essentially of, and the like. Partially-closed ended expressions that exclude anything that would affect the basic and novel characteristics of that which they describe, but otherwise allow anything else. As applied to the description of a bimodal catalyst system embodiment consisting essentially of bis(2-pentamethylphenylamido)ethyl)amine zirconium dibenzyl and (tetramethylcyclopentadienyl)(n-propylcyclopentadienyl)zirconium dichloride, both disposed on a solid support and activated with an activating agent, the expression means the embodiment does not contain a Ziegler-Natta catalyst or any organic ligand other than the bis(2-pentamethylphenylamido)ethyl)amine, benzyl, tetramethylcyclopentadienyl, and n-propylcyclopentadienyl ligands. One or more of the benzyl and chloride leaving groups may be absent from the Zr in the bimodal catalyst system. The expression “consisting essentially of” as applied to the description of the “trim solution means the trim solution is unsupported (i.e., not disposed on a particulate solid) and is free of a Ziegler-Natta catalyst or any organic ligand other than the tetramethylcyclopentadienyl and n-propylcyclopentadienyl ligands. The expression “consist essentially of” as applied to a dry inert purge gas means that the dry inert purge gas is free of, alternatively has less than 5 parts per million based on total parts by weight of gas of water or any reactive compound that could oxidize a constituent of the present polymerization reaction. In some aspects any one, alternatively each “comprising” or “comprises” may be replaced by “consisting essentially of” or “consists essentially of”, respectively; alternatively by “consisting of” or “consists of”, respectively.

Consisting of and consists of. Closed ended expressions that exclude anything that is not specifically described by the limitation that it modifies. In some aspects any one, alternatively each expression “consisting essentially of” or “consists essentially of” may be replaced by the expression “consisting of” or “consists of”, respectively.

(Co)polymerizing conditions. Any result effective variable or combination of such variables, such as catalyst composition; amount of reactant; molar ratio of two reactants; absence of interfering materials (e.g., H₂O and O₂); or a process parameter (e.g., feed rate or temperature), step, or sequence that is effective and useful for the inventive copolymerizing method in the polymerization reactor(s) to give the inventive bimodal poly(ethylene-co-1-hexene) copolymer composition.

At least one, alternatively each of the (co)polymerizing conditions may be fixed (i.e., unchanged) during production of the inventive bimodal poly(ethylene-co-1-hexene) copolymer composition. Such fixed (co)polymerizing conditions may be referred to herein as steady-state (co)polymerizing conditions. Steady-state (co)polymerizing conditions are useful for continuously making embodiments of the inventive bimodal poly(ethylene-co-1-hexene) copolymer composition having same polymer properties.

Alternatively, at least one, alternatively two or more of the (co)polymerizing conditions may be varied within their defined operating parameters during production of the inventive bimodal poly(ethylene-co-1-hexene) copolymer composition in order to transition from the production of a first embodiment of the inventive bimodal poly(ethylene-co-1-hexene) copolymer composition having a first set of polymer properties to a second embodiment of the inventive bimodal poly(ethylene-co-1-hexene) copolymer composition having a second set of polymer properties, wherein the first and second sets of polymer properties are different and are each within the limitations described herein for the inventive bimodal poly(ethylene-co-1-hexene) copolymer composition. For example, all other (co)polymerizing conditions being equal, a higher molar ratio of (C₃-C₂₀)alpha-olefin comonomer/ethylene feeds in the inventive method of copolymerizing produces a lower density of the resulting product inventive bimodal poly(ethylene-co-1-hexene) copolymer composition. At a given molar ratio of comonomer/ethylene, the molar ratio of the procatalyst of the trim solution relative to total moles of catalyst compounds of the bimodal catalyst system may be varied to adjust the density, melt index, melt flow, molecular weight, and/or melt flow ratio thereof. To illustrate an approach to making transitions, perform one of the later described inventive copolymerization examples to reach steady-state (co)polymerizing conditions. Then change one of the (co)polymerizing conditions to begin producing a new embodiment of the inventive bimodal poly(ethylene-co-1-hexene) copolymer composition. Sample the new embodiment, and measure a property thereof. If necessary, repeat the change condition/sample product/measure property steps at intervals until the measurement shows the desired value for the property is obtained. An example of such varying of an operating parameter includes varying the operating temperature within the aforementioned range from 85° to 100° C. such as by changing from a first operating temperature of 90° C. to a second operating temperature of 95° C., or by changing from a third operating temperature of 95° C. to a fourth operating temperature of 90° C. Similarly, another example of varying an operating parameter includes varying the molar ratio of molecular hydrogen to ethylene (H₂/C₂) from 0.0011 to 0.0013, or from 0.0012 to 0.0011. Similarly, another example of varying an operating parameter includes varying the molar ratio of comonomer (corner) to the ethylene (Comer/C₂ molar ratio) from 0.005 to 0.015, alternatively from 0.005 to 0.011, alternatively from 0.006 to 0.011. Combinations of two or more of the foregoing example variations are included herein. Transitioning from one set to another set of the (co)polymerizing conditions is permitted within the meaning of “(co)polymerizing conditions” as the operating parameters of both sets of (co)polymerizing conditions are within the ranges defined therefore herein. A beneficial consequence of the foregoing transitioning is that any described property value for the inventive bimodal poly(ethylene-co-1-hexene) copolymer composition, or the LMW or HMW polyethylene constituent thereof, may be achieved by a person of ordinary skill in the art in view of the teachings herein.

The (co)polymerizing conditions may further include a high pressure, liquid phase or gas phase polymerization reactor and polymerization method to yield the inventive bimodal poly(ethylene-co-1-hexene) copolymer composition. Such reactors and methods are generally well-known in the art. For example, the liquid phase polymerization reactor/method may be solution phase or slurry phase such as described in U.S. Pat. No. 3,324,095. The gas phase polymerization reactor/method may employ the induced condensing agent and be conducted in condensing mode polymerization such as described in U.S. Pat. Nos. 4,453,399; 4,588,790; 4,994,534; 5,352,749; 5,462,999; and 6,489,408. The gas phase polymerization reactor/method may be a fluidized bed reactor/method as described in U.S. Pat. Nos. 3,709,853; 4,003,712; 4,011,382; 4,302,566; 4,543,399; 4,882,400; 5,352,749; 5,541,270; EP-A-0 802 202; and Belgian Patent No. 839,380. These patents disclose gas phase polymerization processes wherein the polymerization medium is either mechanically agitated or fluidized by the continuous flow of the gaseous monomer and diluent. Other gas phase processes contemplated include series or multistage polymerization processes such as described in U.S. Pat. Nos. 5,627,242; 5,665,818; 5,677,375; EP-A-0 794 200; EP-B1-0 649 992; EP-A-0 802 202; and EP-B-634421.

The (co)polymerizing conditions for gas or liquid phase reactors/methods may further include one or more additives such as a chain transfer agent or a scavenging agent. The chain transfer agents are well known and may be alkyl metal such as diethyl zinc. Scavenging agents may be a trialkylaluminum. Slurry or gas phase polymerizations may be operated free of (not deliberately added) scavenging agents. The (co)polymerizing conditions for gas phase reactors/polymerizations may further include an amount (e.g., 0.5 to 200 ppm based on all feeds into reactor) static control agents and/or continuity additives such as aluminum stearate or polyethyleneimine. Static control agents may be added to the gas phase reactor to inhibit formation or buildup of static charge therein.

The (co)polymerizing conditions may further include using molecular hydrogen to control final properties of the LMW and/or HMW polyethylene constituents or inventive bimodal poly(ethylene-co-1-hexene) copolymer composition. Such use of H₂ is generally described in Polypropylene Handbook 76-78 (Hanser Publishers, 1996). All other things being equal, using hydrogen can increase the melt index (MI) or flow index (FI) thereof, wherein MI or FI are influenced by the concentration of hydrogen. A molar ratio of hydrogen to total monomer (H₂/monomer), hydrogen to ethylene (H₂/O₂), or hydrogen to comonomer (H₂/α-olefin) may be from 0.0001 to 10, alternatively 0.0005 to 5, alternatively 0.001 to 3, alternatively 0.001 to 0.10.

The (co)polymerizing conditions may include a partial pressure of ethylene in the polymerization reactor(s) independently from 690 to 3450 kilopascals (kPa, 100 to 500 pounds per square inch absolute (psia), alternatively 1030 to 2070 kPa (150 to 300 psia), alternatively 1380 to 1720 kPa (200 to 250 psia), alternatively 1450 to 1590 kPa (210 to 230 psia), e.g., 1520 kPa (220 psia). 1.000 psia=6.8948 kPa.

Dry. Generally, a moisture content from 0 to less than 5 parts per million based on total parts by weight. Materials fed to the polymerization reactor(s) during a polymerization reaction under (co)polymerizing conditions typically are dry.

Ethylene. A compound of formula H₂C═CH₂. A polymerizable monomer.

Feeds. Quantities of reactants and/or reagents that are added or “fed” into a reactor. In continuous polymerization operation, each feed independently may be continuous or intermittent. The quantities or “feeds” may be measured, e.g., by metering, to control amounts and relative amounts of the various reactants and reagents in the reactor at any given time.

Film: for claiming purposes, properties are measured on 25 micrometers thick monolayer films.

Higher molecular weight (HMW). Relative to LMW, having a higher weight average molecular weight (M_{W}). The HMW polyethylene constituent of the inventive bimodal poly(ethylene-co-1-hexene) copolymer composition may have an M_{W} from 10,000 to 1,000,000 g/mol. The lower endpoint of the M_{W} for the HMW polyethylene constituent may be 20,000, alternatively 50,000, alternatively 100,000, alternatively 150,000, alternatively 200,000, alternatively 250,000, alternatively 300,000 g/mol. The upper endpoint of M_{W} may be 900,000, alternatively 800,000, alternatively 700,000, alternatively 600,000 g/mol. In describing the inventive bimodal poly(ethylene-co-1-hexene) copolymer composition, the bottom portion of the range of M_{W} for the HMW polyethylene constituent may overlap the upper portion of the range of M_{W} for the LMW polyethylene constituent, with the proviso that in any embodiment of the inventive bimodal poly(ethylene-co-1-hexene) copolymer composition the particular M_{W} for the HMW polyethylene constituent is greater than the particular M_{W} for the LMW polyethylene constituent. The HMW polyethylene constituent may be made with catalyst prepared by activating a non-metallocene ligand-Group 4 metal complex.

Inert. Generally, not (appreciably) reactive or not (appreciably) interfering therewith in the inventive polymerization reaction. The term “inert” as applied to the purge gas or ethylene feed means a molecular oxygen (O₂) content from 0 to less than 5 parts per million based on total parts by weight of the purge gas or ethylene feed.

Induced condensing agent (ICA). An inert liquid useful for cooling materials in the polymerization reactor(s) (e.g., a fluidized bed reactor). In some aspects the ICA is a (C₅-C₂₀)alkane, alternatively a (C₁₁-C₂₀)alkane, alternatively a (C₅-C₁₀)alkane. In some aspects the ICA is a (C₅-C₁₀)alkane. In some aspects the (C₅-C₁₀)alkane is a pentane, e.g., normal-pentane or isopentane; a hexane; a heptane; an octane; a nonane; a decane; or a combination of any two or more thereof. In some aspects the ICA is isopentane (i.e., 2-methylbutane). The inventive method of polymerization, which uses the ICA, may be referred to herein as being an induced condensing mode operation (ICMO). Concentration in gas phase measured using gas chromatography by calibrating peak area percent to mole percent (mol %) with a gas mixture standard of known concentrations of ad rem gas phase constituents. Concentration may be from 1 to 10 mol %, alternatively from 3 to 8 mole %.

Lower molecular weight (LMW). Relative to HMW, having a lower weight average molecular weight (M_{W}). The LMW polyethylene constituent of the inventive bimodal poly(ethylene-co-1-hexene) copolymer composition may have an M_{W} from 3,000 to 100,000 g/mol. The lower endpoint of the Mw for the LMW polyethylene constituent may be 5,000, alternatively 8,000, alternatively 10,000, alternatively 12,000, alternatively 15,000, alternatively 20,000 g/mol. The upper endpoint of M_{W} may be 50,000, alternatively 40,000, alternatively 35,000, alternatively 30,000 g/mol. The LMW polyethylene constituent may be made with catalyst prepared by activating a metallocene ligand-Group 4 metal complex. As mentioned above, the bimodal poly(ethylene-co-1-hexene) copolymer composition has at most from greater than 0 to 14 wt % of polyethylene polymers having a Mw of from greater than 0 to 10,000 g/mol, based on total weight of the polyethylene polymers in the bimodal poly(ethylene-co-1-hexene) copolymer composition.

Polyethylene. A macromolecule, or collection of macromolecules, composed of repeat units wherein 50 to 100 mole percent (mol %), alternatively 70 to 100 mol %, alternatively 80 to 100 mol %, alternatively 90 to 100 mol %, alternatively 95 to 100 mol %, alternatively any one of the foregoing ranges wherein the upper endpoint is <100 mol %, of such repeat units are derived from ethylene monomer, and, in aspects wherein there are less than 100 mol % ethylenic repeat units, the remaining repeat units are comonomeric units derived from at least one (C₃-C₂₀)alpha-olefin; or collection of such macromolecules. Low density polyethylene (LDPE): generally having a density from 0.910 to 0.940 g/cm³ measured according to ASTM D792-13 Method B. In some aspects the bimodal poly(ethylene-co-1-hexene) copolymer composition is a bimodal LDPE composition, alternatively a bimodal linear low density polyethylene (LLDPE) composition. LLDPE: generally having a density from 0.910 to 0.940 g/cm³ measured according to ASTM D792-13 Method B and a substantially linear backbone structure.

Procatalyst. Also referred to as a precatalyst or catalyst compound (as opposed to active catalyst compound), generally a material, compound, or combination of compounds that exhibits no or extremely low polymerization activity (e.g., catalyst efficiency may be from 0 or <1,000) in the absence of an activator, but upon activation with an activator yields a catalyst that shows at least 10 times greater catalyst efficiency than that, if any, of the procatalyst.

Resolved (GPC chromatogram). A molecular weight distribution having two peaks separated by an intervening local minimum. For example, a resolved GPC chromatogram of the inventive polymers represented by a plot of dW/dlog(MW) versus log(MW) that features local maxima dW/dlog(MW) values for the LMW and HMW polyethylene constituent peaks, and a local minimum dW/dlog(MW) value at a log(MW) between the maxima. The at least some separation of the peaks for the LMW and HMW polyethylene constituents in the chromatogram of the GPC. Typically the separation may not be down to baseline.

Start-up or restart of the polymerization reactor(s) illustrated with a fluidized bed reactor. The start-up of a recommissioned fluidized bed reactor (cold start) or restart of a transitioning fluidized bed reactor (warm start/transition) includes a time period that is prior to reaching the (co)polymerizing conditions. Start-up or restart may include the use of a seedbed preloaded or loaded, respectively, into the fluidized bed reactor. The seedbed may be composed of powder of polyethylene. The polyethylene of the seedbed may be a PE, alternatively a bimodal PE, alternatively a previously made embodiment of the inventive bimodal poly(ethylene-co-1-hexene) copolymer composition.

Start-up or restart of the fluidized bed reactor may also include gas atmosphere transitions comprising purging air or other unwanted gas(es) from the reactor with a dry (anhydrous) inert purge gas, followed by purging the dry inert purge gas from the reactor with dry ethylene gas. The dry inert purge gas may consist essentially of molecular nitrogen (N₂), argon, helium, or a mixture of any two or more thereof. When not in operation, prior to start-up (cold start), the fluidized bed reactor contains an atmosphere of air. The dry inert purge gas may be used to sweep the air from a recommissioned fluidized bed reactor during early stages of start-up to give a fluidized bed reactor having an atmosphere consisting of the dry inert purge gas. Prior to restart (e.g., after a change in seedbeds or prior to a change in alpha-olefin comonomer), a transitioning fluidized bed reactor may contain an atmosphere of unwanted alpha-olefin, unwanted ICA or other unwanted gas or vapor. The dry inert purge gas may be used to sweep the unwanted vapor or gas from the transitioning fluidized bed reactor during early stages of restart to give the fluidized bed reactor having an atmosphere consisting of the dry inert purge gas. Any dry inert purge gas may itself be swept from the fluidized bed reactor with the dry ethylene gas. The dry ethylene gas may further contain molecular hydrogen gas such that the dry ethylene gas is fed into the fluidized bed reactor as a mixture thereof. Alternatively the dry molecular hydrogen gas may be introduced separately and after the atmosphere of the fluidized bed reactor has been transitioned to ethylene. The gas atmosphere transitions may be done prior to, during, or after heating the fluidized bed reactor to the reaction temperature of the (co)polymerizing conditions.

Start-up or restart of the fluidized bed reactor also includes introducing feeds of reactants and reagents thereinto. The reactants include the ethylene and the alpha-olefin. The reagents fed into the fluidized bed reactor include the molecular hydrogen gas and the induced condensing agent (ICA) and the mixture of the bimodal catalyst system and the trim solution.

Trim solution. Any one of the metallocene procatalyst compounds or the non-metallocene procatalyst compounds described earlier dissolved in the inert liquid solvent (e.g., liquid alkane). The trim solution is mixed with the bimodal catalyst system to make the mixture, and the mixture is used in the inventive polymerization reaction to modify at least one property of the inventive bimodal poly(ethylene-co-1-hexene) copolymer composition made thereby. Examples of such at least one property are density, melt index MI2, flow index FI21, flow rate ratio, and molecular mass dispersity (M_{w}/Mₙ), D_{M}. The mixture of the bimodal catalyst system and the trim solution may be fed into the polymerization reactor(s) in “wet mode”, alternatively may be devolatilized and fed in “dry mode”. The dry mode is fed in the form of a dry powder or granules. When mixture contains a solid support, the wet mode is fed in the form of a suspension or slurry. In some aspects the inert liquid is a liquid alkane such as heptane.

Ziegler-Natta catalysts. Heterogeneous materials that enhance olefin polymerization reaction rates and typically are products that are prepared by contacting inorganic titanium compounds, such as titanium halides supported on a magnesium chloride support, with an activator. The activator may be an alkylaluminum activator such as triethylaluminum (TEA), triisobutylaluminum (TIBA), diethylaluminum chloride (DEAC), diethylaluminum ethoxide (DEAE), or ethylaluminum dichloride (EADC).

Advantageously we discovered the inventive bimodal PE. It unpredictably has at least one improved property such as, for example, increased (greater) slow crack growth resistance (PENT test method), decreased hydrostatic failure (e.g., increased time to hydrostatic failure), and/or increased processability.

Test samples of embodiments of unfilled and filled compositions may be separately made into compression molded plaques. The mechanical properties of these compositions may be characterized using test samples cut from the compression molded plaques.

A compound includes all its isotopes and natural abundance and isotopically-enriched forms. The enriched forms may have medical or anti-counterfeiting uses.

In some aspects any compound, composition, formulation, mixture, or reaction product herein may be free of any one of the chemical elements selected from the group consisting of: H, Li, Be, B, C, N, O, F, Na, Mg, Al, Si, P, S, Cl, K, Ca, Sc, Ti, V, Cr, Mn, Fe, Co, Ni, Cu, Zn, Ga, Ge, As, Se, Br, Rb, Sr, Y, Zr, Nb, Mo, Tc, Ru, Rh, Pd, Ag, Cd, In, Sn, Sb, Te, I, Cs, Ba, Hf, Ta, W, Re, Os, Ir, Pt, Au, Hg, Tl, Pb, Bi, lanthanoids, and actinoids; with the proviso that chemical elements required by the compound, composition, formulation, mixture, or reaction product (e.g., C and H required by a polyolefin or C, H, and O required by an alcohol) are not excluded.

The following apply unless indicated otherwise. Alternatively precedes a distinct embodiment. ASTM means the standards organization, ASTM International, West Conshohocken, Pennsylvania, USA. IEC means the standards organization, International Electrotechnical Commission, Geneva, Switzerland. ISO means the standards organization, International Organization for Standardization, Geneva, Switzerland. Any comparative example is used for illustration purposes only and shall not be prior art. Free of or lacks means a complete absence of; alternatively not detectable. IUPAC is International Union of Pure and Applied Chemistry (IUPAC Secretariat, Research Triangle Park, North Carolina, USA). May confers a permitted choice, not an imperative. Operative means functionally capable or effective. Optional(ly) means is absent (or excluded), alternatively is present (or included). PPM are weight based. Properties are measured using a standard test method and conditions for the measuring (e.g., viscosity: 23° C. and 101.3 kPa). Ranges include endpoints, subranges, and whole and/or fractional values subsumed therein, except a range of integers does not include fractional values. Room temperature: 23° C.±1° C. Substituted when referring to a compound means having, in place of hydrogen, one or more substituents, up to and including per substitution.

Unless noted otherwise herein, use the following preparations for characterizations.

Bimodality Test Method: determine presence or absence of resolved bimodality by plotting dWf/dLogM (mass detector response) on y-axis versus LogM on the x-axis to obtain a GPC chromatogram curve containing local maxima log(MW) values for LMW and HMW polyethylene constituent peaks, and observing the presence or absence of a local minimum between the LMW and HMW polyethylene constituent peaks. The dWf is change in weight fraction, dLogM is also referred to as dLog(MW) and is change in logarithm of molecular weight, and LogM is also referred to as Log(MW) and is logarithm of molecular weight.

Deconvoluting Test Method: segment the chromatogram obtained using the Bimodality Test Method into nine (9) Schulz-Flory molecular weight distributions. Such deconvolution method is described in U.S. Pat. No. 6,534,604. Assign the lowest four MW distributions to the LMW polyethylene constituent and the five highest MW distributions to the HMW polyethylene constituent. Determine the respective weight percents (wt %) for each of the LMW and HMW polyethylene constituents in the inventive bimodal poly(ethylene-co-1-hexene) copolymer composition by using summed values of the weight fractions (Wf) of the LMW and HMW polyethylene constituents and the respective number average molecular weights (Mₙ) and weight average molecular weights (M_{W}) by known mathematical treatment of aggregated Schulz-Flory MW distributions.

Compound Density Test Method: measured on the polyethylene formulation according to ASTM D792-13, Method B, referenced below. Report results in units of kilograms per cubic meter (kg/m³).

Density Test Method: measured according to ASTM D792-13, Standard Test Methods for Density and Specific Gravity (Relative Density) of Plastics by Displacement, Method B (for testing solid plastics in liquids other than water, e.g., in liquid 2-propanol). Report results in units of grams per cubic centimeter (g/cm³).

Flow Index (190° C., 21.6 kg, “I₂₁”) Test Method: use ASTM D1238-13, Standard Test Method for Melt Flow Rates of Thermoplastics by Extrusion Platometer, using conditions of 190° C./21.6 kilograms (kg). Report results in units of grams eluted per 10 minutes (g/10 min.) or the equivalent in decigrams per 1.0 minute (dg/1 min.).

Flow Rate Ratio: (190° C., “I₂₁/I₂”) Test Method: calculated by dividing the value from the Flow Index Fl₂₁ Test Method by the value from the Melt Index I₂ Test Method.

Gel permeation chromatography (GPC) Test Method: Weight-Average Molecular Weight Test Method: determine M_{W}, number average molecular weight (Mₙ), and M_{W}/Mₙ using chromatograms obtained on a High Temperature Gel Permeation Chromatography instrument (HTGPC, Polymer Laboratories). The HTGPC is equipped with transfer lines, a differential refractive index detector (DRI), and three Polymer Laboratories PLgel 10 μm Mixed-B columns, all contained in an oven maintained at 160° C. Method uses a solvent composed of BHT-treated TCB at nominal flow rate of 1.0 milliliter per minute (mL/min.) and a nominal injection volume of 300 microliters (μL). Prepare the solvent by dissolving 6 grams of butylated hydroxytoluene (BHT, antioxidant) in 4 liters (L) of reagent grade 1,2,4-trichlorobenzene (TCB), and filtering the resulting solution through a 0.1 micrometer (μm) Teflon filter to give the solvent. Degas the solvent with an inline degasser before it enters the HTGPC instrument. Calibrate the columns with a series of monodispersed polystyrene (PS) standards. Separately, prepare known concentrations of test polymer dissolved in solvent by heating known amounts thereof in known volumes of solvent at 160° C. with continuous shaking for 2 hours to give solutions. (Measure all quantities gravimetrically.) Target solution concentrations, c, of test polymer of from 0.5 to 2.0 milligrams polymer per milliliter solution (mg/mL), with lower concentrations, c, being used for higher molecular weight polymers. Prior to running each sample, purge the DRI detector. Then increase flow rate in the apparatus to 1.0 mL/min/, and allow the DRI detector to stabilize for 8 hours before injecting the first sample. Calculate M_{W} and Mₙ using universal calibration relationships with the column calibrations. Calculate MW at each elution volume with following equation:

$$log {M}_{X} = \frac{log ( {K}_{X} / {K}_{PS} )}{{a}_{X} + 1} + \frac{{a}_{P S} + 1}{{a}_{X} + 1} log {M}_{P S} ,$$

where subscript “X” stands for the test sample, subscript “PS” stands for PS standards, a_{PS}=0.67, K_{PS}=0.000175, and aₓ and Kₓ are obtained from published literature. For polyethylenes, aₓ/Kₓ=0.695/0.000579. For polypropylenes aₓ/Kₓ=0.705/0.0002288. At each point in the resulting chromatogram, calculate concentration, c, from a baseline-subtracted DRI signal, I_{DRI}, using the following equation: c=K_{DRI}I_{DRI}/(dn/dc), wherein K_{DRI} is a constant determined by calibrating the DRI, / indicates division, and dn/dc is the refractive index increment for the polymer. For polyethylene, dn/dc=0.109. Calculate mass recovery of polymer from the ratio of the integrated area of the chromatogram of concentration chromatography over elution volume and the injection mass which is equal to the pre-determined concentration multiplied by injection loop volume. Report all molecular weights in grams per mole (g/mol) unless otherwise noted. Further details regarding methods of determining Mw, Mn, MWD are described in U.S. 2006/0173123 page 24-25, paragraphs [0334] to [0341]. Plot of dW/dLog(MW) on the y-axis versus Log(MW) on the x-axis to give a GPC chromatogram, wherein Log(MW) and dW/dLog(MW) are as defined above.

Melt Index (190° C., 2.16 kilograms (kg), “I₂”) Test Method: for ethylene-based (co)polymer is measured according to ASTM D1238-13, using conditions of 190° C./2.16 kg, formerly known as “Condition E” and also known as MI₂. Report results in units of grams eluted per 10 minutes (g/10 min.) or the equivalent in decigrams per 1.0 minute (dg/1 min.). 10.0 dg=1.00 g. Melt index is inversely proportional to the weight average molecular weight of the polyethylene, although the inverse proportionality is not linear. Thus, the higher the molecular weight, the lower the melt index.

Minimum Required Strength (MRS) Test Method: minimum required strength (MRS) of at least 8.0 MPa, determined in accordance with ISO 9080:2003 (“Plastics piping and ducting systems—determination of long term hydrostatic strength of thermoplastics materials in pipe form by extrapolation”) from long-term pressure testing conducted according to ISO 12162:2009 (“Thermoplastics materials for pipes and fittings for pressure applications—Classification and designation—overall Service (Design) coefficient”).

PENT Test Method (90° C., 2.4 MPa): ASTM F1473-16, Standard Test Method for Notch Tensile Test to Measure the Resistance to Slow Crack Growth of Polyethylene Pipes and Resins. Also known as the Pennsylvania Notch Test (“PENT”). Prepare test specimens from compression molded plaques, precisely notch specimens, and then expose notched specimens to a constant tensile stress at elevated temperature in air.

Pipe Hydrostatic Test Methods 1 and 2 (90° C., 3.8 or 4.0 MPa, respectively): Characterized as a PE-80 pipe resin material that when evaluated in accordance with ISO 9080 or equivalent, with internal pressure tests being carried out in accordance with ISO 1167-1 and ISO 1167-2, the inventive composition conforms to the 4-parameter model given in ISO 24033 for PE-80 pipe resin material over a range of temperature and internal pressure as provided in ISO 22391. As a short-term screening test (“water-in-water”), perform hydrostatic testing, as described in ISO 22391-2, pipes composed of test material by following ISO 24033:2009 at two specific hydrostatic conditions, namely 3.8 MPa and 90° C. or 4.0 MPa and 90° C. The pipes for testing are SDR 11 pipes having a 1-inch (25.4 mm) diameter, a 0.12 inch (3 mm) wall thickness, and a length of 18 inches (457 mm). The pipes are prepared by extrusion of polymer melt at a temperature inside the extruder maintained at 204.4° C. (400° F.) and polymer feed rate of 130.6 kg/hour (288 pounds/hour) using a Maplan model SS60-30 pipe extruder having an annular die defining a die-gap opening. The molten pipe profile coming out of the annular die is drawn down from the die-gap opening into the interior of a sizing sleeve by a puller located further downstream and operating at a puller speed of 8.1 meters per minute (26.57 feet/minute). As pipe is moved through the sizing sleeve, a vacuum pulls the molten pipe profile against the interior of the sleeve. Cooling Water enters the sizing sleeve, cooling the pipe and maintaining established dimensions and smooth surface.

Resistance to Slow Crack Growth Test Method 1. Measured at 0.8 megapascal (MPa; 8.0 bar) pressure according to ISO 13479:2009 (Polyolefin pipes for the conveyance of fluids—Determination of resistance to crack propagation—Test method for slow crack growth on notched pipes).

Resistance to Slow Crack Growth Test Method 2. Measured at 80° C. and 2.4 megapascals (MPa) pressure according to a Pennsylvania Notch Test (“PENT”) according to ASTM F1473-18 (Standard Test Method for Notch Tensile Test to Measure the Resistance to Slow Crack Growth of Polyethylene Pipes and Resins).

Bimodal catalyst system 1: consisted essentially of or made from bis(2-pentamethylphenylamido)ethyl)amine zirconium dibenzyl and (tetramethylcyclopentadienyl)(n-propylcyclopentadienyl)zirconium dichloride spray-dried in a 3:1 molar ratio onto CAB-O-SIL TS610, a hydrophobic fumed silica made by surface treating hydrophilic (untreated) fumed silica with dimethyldichlorosilane support, and methylaluminoxane (MAO), and fed into a gas phase polymerization reactor as a slurry in mineral oil. The molar ratio of moles MAO to (moles of bis(2-pentamethylphenylamido)ethyl)amine zirconium dibenzyl+moles (tetramethylcyclopentadienyl)(n-propylcyclopentadienyl)zirconium dichloride) was 140:1.

Comonomer 1: 1-Hexene (“C₆”), used at a molar ratio of 1-hexene/ethylene (“C₆/C₂”) in Table 1.

Ethylene (“C₂”): partial pressure of C₂ was maintained as described later in Table 1.

Induced condensing agent 1 (“ICA1”): isopentane, used at a mole percent (mol %) concentration in the gas phase of a gas phase reactor relative to the total molar content of gas phase matter. Reported later in Table 1.

Molecular hydrogen gas (“H₂”): used at a molar ratio of H₂/C₂ in Table 1.

Trim solution 1: consisted essentially of or made from (tetramethylcyclopentadienyl)(n-propylcyclopentadienyl)zirconium dimethyl (procatalyst) dissolved in heptane to give a solution having a concentration of 0.7 gram procatalyst per milliliter solution (g/mL). The trim solution is further diluted in isopentane to a concentration of 0.04 wt %.

Comparative Example 1 (CE1): a comparative bimodal poly(ethylene-co-1-hexene) copolymer composition. This is made according to the process described in, and the composition is the same as, inventive example 2 of WO 2019/046085 A1. Properties of CE1 are summarized later in Table 2.

Inventive Example 1 (IE1, Prophetic): make the bimodal poly(ethylene-co-1-hexene) copolymer composition of IE1 in a single gas phase polymerization reactor containing a commercial manufacturing plant scale continuous mode, gas phase fluidized bed reactor. For a production run, preload the reactor before startup with a seedbed of granular resin inside. Dry down the reactor with the seedbed below 5 ppm moisture with high purity nitrogen. Inject continuity additive (a 50:50 (wt/wt) mixture of bis 2-hydroxyethyl stearyl amine and aluminum distearate dispersed in mineral oil) to pretreat the seed bed to attain a 60 parts per million weight (ppmw) level based on weight of the 50:50 (wt/wt) mixture to bed weight. At steady-state polymerization run, additional continuity additive may be injected so as to maintain 45 ppmw of the 50:50 (wt/wt) mixture in the reactor per weight of bimodal poly(ethylene-co-1-hexene) copolymer composition being made. Then introduce reaction constituent gases to the reactor to build a gas phase condition. At the same time heat the reactor up to the desired temperature. Charge the reactor with hydrogen gas sufficient to produce a molar ratio of hydrogen to ethylene of 0.0012 at the reaction conditions, and charge the reactor with 1-hexene to produce a molar ratio of 1-hexene to ethylene of 0.01 at reaction conditions. Pressurize the reactor with ethylene (pressure 1.52 MPa, =220 psi) and keep the reactor temperature at 95° C. Once the (co)polymerizing conditions are reached, inject a feed of a slurry of Bimodal Catalyst System1 into the reactor. Meanwhile mix a trim solution feed with the feed of Bimodal Catalyst System1 to give a mixture thereof, and then feed same into the reactor to fine tune flow index and melt index of inventive bimodal poly(ethylene-co-1-hexene) copolymer composition to desired target values. Use about three bed turnovers to reach steady-state production thereof, thereby giving the embodiment of the inventive bimodal PE (product) of IE1. Collect the inventive bimodal PE of IE1 from the reactor's product discharge outlet and characterized its properties. Made using the expected operating constituents and parameters are summarized below in Table 1. Expected properties of the product inventive bimodal poly(ethylene-co-1-hexene) copolymer composition of IE1 are summarized later in Table 2.

Inventive Example 2 (IE2, Prophetic): replicate the procedure of IE1 except with the following process condition changes: a molar ratio of 1-hexene to ethylene (C₆/C₂ molar ratio) less than 0.01. Made using the expected operating constituents and parameters are summarized below in Table 1. Expected properties of the product inventive bimodal poly(ethylene-co-1-hexene) copolymer composition of IE2 are summarized later in Table 2.

TABLE 1
Operating constituents/parameters for Inventive Example IE1 and IE2.

| Reaction Constituent/Parameter | (co)polymerizing condition |
|---|---|
| Reactor | single, continuous-mode, |
| | fluidized bed |
| Starting seedbed = granular PE resin | Preloaded in reactor |
| Bed weight | 39,000 kg |
| Reactor Purging method | Anhydrous N₂ gas |
| Ethylene (“C₂”) | 1.52 MPa partial pressure |
| Comonomer = 1-hexene (“C₆”) | molar ratio of C₆/C₂ = 0.008 to |
| | 0.015 |
| Molecular hydrogen gas (“H₂”) | molar ratio of H₂/C₂ = 0.0012 |
| Induced Condensing Agent 1: isopentane | 7 to 11 mol % |
| Operating temperature | 95° C. |
| Superficial gas velocity (SGV, | 0.60 to 0.73 |
| meters/second) | |

TABLE 2
properties of CE1, IE1, IE2.

| | CE1 | E1 | IE2 |
|---|---|---|---|
| Polymer Properties | (Measured) | (Prophetic*) | (Prophetic*) |
| Density (ASTM D792-13) | 0.936 g/cm³ | 0.936 g/cm³ | 0.940 g/cm³ |
| Melt Index I₂ (190° C., | 0.063 g/10 | 0.08 to 0.10 | 0.07 to 0.09 |
| 2.16 kg, | min. | g/10 min. | g/10 min. |
| ASTM D1238-04) | | (e.g., 0.09 | (e.g., 0.08 |
| | | g/10 min.) | g/10 min.) |
| Flow Index I₂₁ (190° C., 21.6 | 10.9 g/10 | 12 g/10 min. | 10 g/10 min. |
| kg, ASTM D1238-04) | min. | | |
| Flow Rate Ratio (I₂₁/I₂) | 173 | 133 | 125 |
| Melt Index I₅ (190° C., | 0.4 g/10 | 0.40 to 0.50 | 0.25 to 0.35 |
| 5.00 kg, | min. | g/10 min. | g/10 min. |
| ASTM D1238-04) | | (e.g., 0.45 | (e.g., 0.30 |
| | | g/10 min.) | g/10 min.) |
| Amount of ethylenic-containing | TBD | 1 to 14 wt % | 1 to 14 wt % |
| chains having MW of from | | | |
| >0 to 10,000 g/mol | | | |
| Composition Molecular mass | 13.8 | About 17 | About 17 |
| dispersity (M_{w}/Mₙ), Ð_{M} | | | |
| Resolved Bimodality (GPC | Yes, at 5.2 | Yes, | Yes, between |
| local minimum) | LogM | between 5.0 | 5.0 and 6.0 |
| | | and 6.0 | |

*Polymer properties and test results listed for IE1 and IE2 are designed and expected.
TBD means to be determined.

Comparative Example (A): Preparation of pipes from the comparative bimodal PE of CE1, which pipes are the same as prior inventive example (B) of WO 2019/046085 A1. Properties are listed in Table 3 below.

Inventive Examples (A) and (B): Prophetic preparation of pipes from the inventive bimodal PE of IE1 and IE2, respectively. Use composition IE1 or IE2 to prepare SDR 11 pipes according to Pipe Hydrostatic Test Method 1 or 2 above. Designed and expected properties are listed in Table 3 below.

TABLE 3
pipe properties of CE(A), IE(A), and IE(B).

| | | IE(A) | IE(B) |
|---|---|---|---|
| Pipe Properties | CE(A) | (Prophetic*) | (Prophetic*) |
| PENT Test Method (hours) | >1000 | TBD | TBD |
| Pipe Hydrostatic Test Method 2 | >2000 | TBD | TBD |
| (90° C., 4.0 MPa) | hours | | |
| Pipe Hydrostatic Test Method 1 | >2000 | TBD | TBD |
| (90° C., 3.8 MPa) | hours | | |
| minimum required strength (MRS) | TBD | At least 8.0 | At least 8.0 |
| (ISO 9080:2003 from | | MPa | MPa |
| long-term pressure | | | |
| testing ISO 12162:2009) | | | |
| Resistance to slow crack growth | TBD | At least 500 | At least 500 |
| (at 0.8 MPa, ISO 13479:2009) | | hours | hours |
| Resistance to slow crack growth (at | TBD | 500 to 9900 | 500 to 9900 |
| 80° C. and 2.4 MPa, PENT ASTM | | hours | hours |
| F1473-18) | | | |

*Pipe properties for IE(A) and IE(B) prepared from IE1 and IE2, respectively, are designed and expected.
TBD means to be determined.

The inventive bimodal poly(ethylene-co-1-hexene) copolymer composition of IE1 or IE2 will have a compound density ≥930 kg/m³, a melt index I₅ 0.2 to 1.4 g/10 min. (190° C., 5.00 kg); a Minimum Required Strength (MRS) per ISO 9080 of at least 8.0 MPa, and a slow crack growth resistance per ISO 13479 of at least 500 hours at 8.0 MPa (8.0 bar).

1. A bimodal poly(ethylene-co-1-hexene) copolymer composition comprising a lower molecular weight poly(ethylene-co-1-hexene) copolymer constituent (LMW Copolymer) and a higher molecular weight poly(ethylene-co-1-hexene) copolymer constituent (HMW Copolymer), wherein each of the LMW Copolymer and HMW Copolymer independently consists essentially of ethylene-derived monomeric units and 1-hexene-derived comonomeric units; and wherein the bimodal poly(ethylene-co-1-hexene) copolymer composition is characterized by each of limitations (a) to (h): (a) a resolved bimodality (resolved molecular weight distribution) showing in a chromatogram of gel permeation chromatography (GPC) of the bimodal low density polyethylene composition, wherein the chromatogram shows a peak representing the HMW Copolymer, a peak representing the LMW Copolymer, and a local minimum therebetween in a range of Log(molecular weight) (“Log(MW)”) 5.0 to 7.0, measured according to the Bimodality Test Method; (b) a density from 0.935 to 0.941 gram per cubic centimeter (g/cm³) measured according to ASTM D792-13 Method B; (c) a melt index measured according to ASTM D1238-13 at 190 degrees C. (° C.) under a load of 2.16 kilograms (kg) (“I₂”) from 0.05 to 0.14 gram per 10 minutes (g/10 min.); (d) a flow index measured according to ASTM D1238-13 at 190° C. under a load of 21.6 kg (“I₂₁”) from 9.0 to 13 g/10 min.; (e) a flow rate ratio of the melt index to the flow index (“I₂₁/I₂”) from 100.0 to 250.0; (f) from 1 to 14 weight percent (wt %) of ethylenic-containing chains having a formula molecular weight (MW) of from greater than 0 to 10,000 grams per mole (g/mol), based on total weight of ethylenic-containing constituents in the bimodal poly(ethylene-co-1-hexene) copolymer composition; (g) a molecular mass dispersity (M_{W}/Mₙ), D_{M}, from 7 to 25 measured according to the Gel Permeation Chromatography (GPC) Test Method; and (h) a melt index measured according to ASTM D1238-13 at 190 degrees C. (° C.) under a load of 5.00 kilograms (kg) (“I₅” or “MI5”) from 0.25 to 0.50 gram per 10 minutes (g/10 min.).

2. The bimodal poly(ethylene-co-1-hexene) copolymer composition of claim 1 characterized by at least one of limitations (a) to (h): (a) the local minimum in the GPC chromatogram is from 5.0 to 6.0 Log(MW), measured according to the Bimodality Test Method; (b) density from 0.935 to 0.937 g/cm³, measured according to ASTM D792-13 Method B; (c) melt index (I₂) of 0.08 to 0.10 g/10 min. measured according to ASTM D1238-13 (190° C., 2.16 kg); (d) flow index (I₂₁) of 11 to 13 g/10 min.; (e) a flow rate ratio (I₂₁/I₂) from 115 to 150; and (f) from 7.0 to less than 12.0 wt % of ethylenic-containing chains having MW of from greater than 0 to 10,000 g/mol, based on total weight of the ethylenic-containing constituents in the bimodal poly(ethylene-co-1-hexene) copolymer composition; (g) molecular mass dispersity (M_{W}/Mₙ), D_{M}, from 15 to 20 measured according to the Gel Permeation Chromatography (GPC) Test Method; and (h) a melt index measured according to ASTM D1238-13 at 190 degrees C. (° C.) under a load of 5.00 kilograms (kg) (“I₅” or “MI5”) from 0.40 to 0.50 g/10 min.

3. The bimodal poly(ethylene-co-1-hexene) copolymer composition of claim 1 characterized by at least one of limitations (a) to (h): (a) the local minimum in the GPC chromatogram is from 5.0 to 6.0 Log(MW), measured according to the Bimodality Test Method; (b) density from 0.939 to 0.941 g/cm³, measured according to ASTM D792-13 Method B; (c) melt index (I₂) of from 0.07 to 0.09 g/10 min. measured according to ASTM D1238-13 (190° C., 2.16 kg); (d) flow index (I₂₁) of 9.0 to 11 g/10 min.; (e) a flow rate ratio (I₂₁/I₂) from 115 to 150; and (f) from 7.0 to less than 12.0 wt % of ethylenic-containing chains having MW of from greater than 0 to 10,000 g/mol, based on total weight of the ethylenic-containing constituents in the bimodal poly(ethylene-co-1-hexene) copolymer composition; and (g) molecular mass dispersity (M_{W}/Mₙ), D_{M}, from 15 to 20 measured according to the Gel Permeation Chromatography (GPC) Test Method; and (h) a melt index measured according to ASTM D1238-13 at 190 degrees C. (° C.) under a load of 5.00 kilograms (kg) (“I₅” or “MI5”) from 0.25 to 0.35 g/10 min.

4. The bimodal poly(ethylene-co-1-hexene) copolymer composition of claim 1 further characterized by any one of limitations (i) to (k): (i) a minimum required strength (MRS) of at least 8.0 MPa, determined in accordance with ISO 9080:2003 from long-term pressure testing conducted according to ISO 12162:2009; (j) a resistance to slow crack growth of at least 500 hours, measured at 0.8 megapascal (MPa; 8.0 bar) pressure according to ISO 13479:2009; (k) a resistance to slow crack growth of from 500 to 9,990 hours, measured at 80° C. and 2.4 megapascals (MPa) pressure according to a Pennsylvania Notch Test (“PENT”) according to ASTM F1473-18.

5. A method of making the bimodal poly(ethylene-co-1-hexene) copolymer composition of claim 1, the method comprising contacting ethylene (monomer) and 1-hexene (comonomer) with a mixture of a bimodal catalyst system and a trim solution in the presence of molecular hydrogen gas (H₂) and an induced condensing agent (ICA) in one polymerization reactor under copolymerizing conditions, thereby making the bimodal poly(ethylene-co-1-hexene) copolymer composition; wherein prior to being mixed together the trim solution consists essentially of a (tetramethylcyclopentadienyl)(n-propylcyclopentadienyl)zirconium dimethyl complex and an inert liquid solvent (e.g., mineral oil) and the bimodal catalyst system consists essentially of an activator species, a non-metallocene ligand-Group 4 metal complex, and a metallocene ligand-Group 4 metal complex, a solid support, and, optionally, a mineral oil; and wherein the copolymerizing conditions comprise a reaction temperature from 94° to 96° C.; a molar ratio of the molecular hydrogen gas to the ethylene (H₂/C₂ molar ratio) from 0.0011 to 0.0013; and a molar ratio of the 1-hexene comonomer (C₆) to the ethylene (C₆/C₂ molar ratio) from 0.008 to 0.015.

6. The method of claim 5 wherein the non-metallocene ligand-Group 4 metal complex consists essentially of bis(2-pentamethylphenylamido)ethyl)amine zirconium dibenzyl complex and the metallocene ligand-Group 4 metal complex consists essentially of (tetramethylcyclopentadienyl)(n-propylcyclopentadienyl)zirconium dimethyl complex in a molar ratio thereof from 1.0:1.0 to 5.0:1.0; and wherein the activator species is a methylaluminoxane species; and wherein the solid support is a hydrophobic fumed silica, and wherein the bimodal catalyst system is made by spray-drying a mixture of the non-metallocene ligand-Group 4 metal complex, the metallocene ligand-Group 4 metal complex, and the activator species onto the solid support.

7. A polyethylene formulation comprising the bimodal poly(ethylene-co-1-hexene) copolymer composition of claim 1 and at least one additive selected from the group consisting of one or more antioxidants, a polymer processing aid, a colorant, a lubricant, and a metal deactivator.

8. A manufactured article comprising a shaped form of the bimodal poly(ethylene-co-1-hexene) copolymer composition of any one of claims 1 to 4 or a shaped form of the polyethylene formulation of claim 7.

9. A pipe defining an interior volumetric space through which a substance may be conveyed, wherein the pipe is composed of either the bimodal poly(ethylene-co-1-hexene) copolymer composition claim 1; and wherein the pipe is characterized by the limitations (i) and (j) and, optionally, limitation (k): (i) a minimum required strength (MRS) of at least 8.0 MPa, determined in accordance with ISO 9080:2003 from long-term pressure testing conducted according to ISO 12162:2009; and (j) a resistance to slow crack growth of at least 500 hours, measured at 0.8 megapascal (MPa; 8.0 bar) pressure according to ISO 13479:2009; and, optionally, (k) a resistance to slow crack growth of from 500 to 9,990 hours, measured at 80° C. and 2.4 megapascals (MPa) pressure according to a Pennsylvania Notch Test (“PENT”) according to ASTM F1473-18.

10. A method of conveying a substance, the method comprising moving a substance through the interior volumetric space of the pipe of claim 9.
